(19) United States
(12) Patent Application Publication
(10) Pub. No.: US 2025/0362228 A1
(43) Pub. Date: Nov. 27, 2025

(54) MEASURING A TARGET VALUE WITH A NIR MODEL

(71) Applicant: TRINAMIX GMBH, Ludwigshafen Am Rhein (DE)

(72) Inventors: Sebastian FRISCHKORN, Ludwigshafen am Rhein (DE); Michel Valentin KETTNER, Ludwigshafen am Rhein (DE); Michael HANKE, Ludwigshafen am Rhein (DE); Florian PROELL, Ludwigshafen am Rhein (DE)

(21) Appl. No.: 18/872,396

(22) PCT Filed: Jun. 28, 2023
(86) PCT No.: PCT/EP2023/067603

§ 371 Date: Dec. 6, 2024

(30) Foreign Application Priority Data
Jul. 7, 2022 (EP) 22183538.2

(51) Int. Cl. G01N 21/359; G06F 18/21; G06F 18/214

(52) U.S. Cl. CPC G01N 21/359; G06F 18/214; G06F 18/2178; G01N 2201/129

(57) ABSTRACT

Disclosed herein is a computer-implemented method for measuring a target value with a NIR model including:
(a) receiving NIR spectral data,
(b) determining at least one target value with the trained NIR model based on the spectral data, where the NIR model was trained based on NIR training data including at least one model-based reference value determined with a reference model and historical NIR spectral data, and
(c) providing the at least one target value.

### DESCRIPTION

The present invention is in the field of measuring a target value with a NIR model. In particular, it relates to a computer-implemented method for providing a model-based reference value, a computer-implemented method for training a reference model suitable for providing a model-based reference value, use of a model-based reference value for training a NIR model, use of a model-based reference value for training a reference model, system for providing a model-based reference value, a non-transitory computer-readable data medium storing a computer program including instructions for executing steps of the method according to any one of the preceding claims, to a system for training a reference model, a computer-implemented method for measuring a target value, a system for measuring a target value.

### BACKGROUND

Near-infrared (NIR) spectra usually comprises a large number of wavelengths with a corresponding absorption of the material of each wavelength resulting in highly overlapping bands thereby being difficult to interpret. For determining a desired property from the spectra usually NIR models trained with reference values are used. Such reference values are normally obtained by means of analytical methods but require effort for the person wanting to interpret NIR spectra to take samples and deliver those to a laboratory capable of performing analytical methods, time to take the samples, deliver them and wait for the results and high costs for the analytical analysis.

To reduce the needed amount of analytical reference values, WO2014137564A1 developed a type of NIR model that can be trained with a comparable low amount of analytical reference values. Still, each NIR model is trained with at least some analytical reference values.

It was hence the object of the present invention to overcome these shortcomings. In particular, a method for providing a target value with a NIR model requiring less analytical reference is desired. This method should be easy, reliable and accurate.

### SUMMARY

These objects were achieved by the present invention. In one aspect it relates to a computer-implemented method for measuring a target value with a NIR model comprising:
(a) receiving NIR spectral data,
(b) determining the at least one target value with the trained NIR model based on the spectral data, wherein the NIR model was trained based on NIR training data comprising at least one model-based reference value determined with a reference model and historical NIR spectral data,
(c) providing the at least one target value

In another aspect it relates to a computer-implemented method for training a reference model suitable for providing a model-based reference value comprising:
(a) receiving reference training data comprising at least one analytical reference value and historical metadata related to at least one reference value,
(b) training the reference model based on the reference training data,
(c) providing the reference model.

In another aspect it relates to a computer-implemented method for training a NIR model comprising:
(a) receiving NIR training data comprising historical NIR spectral data and at least one model-based reference value determined with a reference model based on metadata corresponding to the historical spectral data,
(b) training the NIR model based on the historical NIR spectral data and the at least one model-based reference value,
(c) providing the NIR model.

In another aspect it relates to a computer-implemented method for providing a model-based reference value comprising:
(a) receiving metadata related to at least one reference value,
(b) determining the at least one model-based reference value based on metadata by using a reference model which has been trained by reference training data comprising at least one analytical reference value and historical metadata,
(c) outputting the at least one model-based reference value. (d)

In yet another aspect it relates to a use of a model-based reference value for training a NIR model.

In yet another aspect it relates to a use of a model-based reference value for training a reference model other than the reference model that determined the at least one model-based reference value.

In yet another aspect it relates to a system for providing a model-based reference value comprising:
(a) an input for receiving metadata related to at least one reference value and at least one analytical reference value,
(b) a processor for determining the at least one model-based reference value based on the reference training data with a reference model which has been trained by training data comprising at least one analytical reference value and historical metadata,
(c) an output for outputting the at least one model-based reference value.

In yet another aspect it relates computer program comprising instructions which, when the program is executed carry out the steps of the methods as described herein.

In yet another aspect it relates non-transitory computer-readable data medium storing a computer program as described above.

In yet another aspect it relates to a system for training a reference model suitable for providing a model-based reference value comprising:
(a) an input for receiving reference training data comprising at least one analytical reference value and historical metadata related to at least one reference value,
(b) a processor for training the reference model based on the reference training data,
(c) an output for outputting the reference model.

In yet another aspect it relates to a system for training a NIR model suitable for providing a target value comprising:
(a) an input for receiving NIR training data comprising at least one model-based reference value and historical NIR spectral data,
(b) a processor for training the NIR model based on the NIR training data,
(c) an output for providing the NIR model.

In yet another aspect it relates to a system for measuring a target value comprising:
(a) an input for receiving NIR training data comprising historical NIR spectral data and at least one model-based target value determined based on metadata provided to a reference model and NIR spectral data with a NIR model,
(b) a processor for training the NIR model based on the NIR training data and determining the at least one target value based on NIR spectral data with the trained NIR model
(c) an output for providing the at least one target value.

The present invention provides means for providing efficient and robust way for providing a target value requiring less analytical reference values. Usually, NIR models are used for the interpretation of NIR spectra since NIR spectra comprise highly overlapping bands and provide a high amount of data that needs to be taken into account. For this purpose, NIR models are trained with historical spectra and reference values. Such reference values comprise information that can be deduced from the spectra and are known. In contrast, target values comprise information yet to be determined with the trained NIR model based on spectra. Reference values obtained by analytical methods are high cost, take a lot of time for taking the samples and waiting for the results and need material samples that need to be removed thereby requiring an intervention into the system to be analyzed. In contrast, model-based reference values are low-cost, time saving and accurate. Requiring less analytical reference improves the interpretation of NIR spectra via NIR models by lowering the costs, simplifying the process, shortening the needed time for providing a trained a NIR model ultimately speeding up the process for users of NIR models requiring new and/or retrained NIR models and disturbance of the system to be analyzed due to sample-taking is reduced. Overall, the measurement of target values is improved.

Any disclosure and embodiments described herein relate to the methods, the systems, the uses, the computer program element lined out above and vice versa. Advantageously, the benefits provided by any of the embodiments and examples equally apply to all other embodiments and examples and vice versa. The system may be suitable for carrying out the steps of the methods.

By using NIRS, at least one material information can be obtained from a material. A material comprises at least one chemical substance. Chemical substance may be one of but not limited to chemical compound, alloy, polymers, pure chemical element and/or the like. Chemical compounds may comprise atoms from more than one element held together by a chemical bond. Chemical compounds may for example include molecules composed of atoms from more than one element, ionic compounds, intermetallic compounds, complexes or the like.

“Material information” refers to quantitative information and/or qualitative information and/or material properties. Quantitative information may comprise information associated with an amount of at least one chemical substance in a material. The amount may be a relative amount relating the amount of the at least one chemical substance to the total amount of the material and/or to the amount of at least another chemical substance. The amount may be an absolute amount of a chemical substance in a material. Amount may be determined as amount-of-substance fraction, mass fraction volume fraction and/or the like.

Qualitative information may comprise to information suitable for identifying the at least one chemical substance comprised in a material. A chemical substance may be identified via at least one structural part of the chemical substance. Structural part may correspond to at least one atom comprised in the chemical substance. Preferably, structural part may correspond to at least two atoms comprised in the chemical substance, most preferably the two atoms may be connected via a chemical bond. For example, a structural part may comprise a chemical functional group. Furthermore, qualitative information and/or quantitative information may be related to material properties.

Material properties may comprise physical and/or chemical properties. A physical property may refer to properties describing the physical state of a material. Physical property may be one of the following: mechanical properties, electrical properties, optical properties, thermal properties or the like. Examples for physical properties may be concentration, color or absorption. A chemical property may be a property defined by the structure of the at least one chemical substance. Chemical property is a property that can be established only by changing the structure of the at least one chemical substance. Examples for chemical properties may be acidity, oxidation state or reactivity.

Target value may comprise material information. At least one target value may be determined based on the NIR spectral data, preferably by using a NIR model. Target value may be determined for a material. Target value may refer to a value to be determined, desired and/or not yet known. Target value may be a numerical value of a measure. Measure of a target value may be a measure related to material information.

“NIR spectral data” refers to data obtained by performing NIRS. NIR spectral data may be data associated with a NIR spectrum. NIR spectral data may comprise a measure for absorption of light with a defined energy in relation to a measure of the defined energy of the light. For example, NIR spectral data may comprise intensities or measure related to or derived from the intensity plotted against a measure for the defined energy of the light, e.g. wavelength wave-number and/or an energy unit (for example given in eV or J). The measure for the defined energy of the light in NIR spectral data may be in the infrared range, in particular in the near-infrared range. NIR spectral data may be obtained with a NIR spectrometer, in particular a handheld NIR spectrometer. NIR spectral data may comprise NIR historical data.

A “reference value” as used herein is understood to be suitable for parametrizing a NIR model and/or a reference model. At least one reference value may be provided to the NIR model or the reference model for parametrizing. Reference value may comprise material information. Reference value may be determined independently from the NIR spectral data. Reference value may comprise analytical and/or model-based reference value. Analytical reference value may be determined by analytical methods. Model-based reference value may be determined independently from analytical methods. Model-based reference value may be determined with a reference model trained based on at least one analytical reference value and metadata. Analytical methods may comprise wet-chemical analysis and instrumental analytics. Wet-chemical analysis may comprise detection reactions, flame coloration, photometry, titration, gravimetry or the like. Instrumental analytics may comprise spectroscopy, chromatography, electrochemical measurements, use of sensors. Spectroscopy may comprise spectroscopy with electromagnetic radiation such as UV/VIS, x-rays, IR light or the like; mass spectroscopy; nuclear magnetic spectroscopy or the like. A reference value may be a historical target value. Reference value may be a target value already known. Reference value may be a numerical value of a measure. Measure of a reference value may be a measure of material information.

“Metadata” as used herein is understood to be data determined independently from NIR spectral data. Metadata may be determined independently from NIRS. Metadata may comprise data related to the conditions of determining NIR spectral data. Conditions of determining NIR spectral data may comprise human-adjustable parameters and/or human-non-adjustable parameters. Metadata may be associated with the at least one reference value and/or the at least one target value. Metadata may be suitable for determining the at least one reference value and/or the at least one target value. Metadata may be inputted into a reference model for determining the at least one reference value. Metadata may be comprised in the reference training data and/or the NIR training data. Metadata may be inputted into a NIR model for determining the at least one target value. Metadata may comprise human-adjustable parameters and/or human-non-adjustable parameters. It is to be understood that the metadata depends on the use case for the method to be applied to. Metadata may comprise historical metadata.

Historical data may refer to data used for training models. In particular, data may be historical if the data was generated at a point in time before non-historical data was generated.

Human-adjustable parameters are parameters that can be controlled by humans. Human-adjustable parameters may relate to the material and/or to the surrounding of the material. Human-adjustable parameters may comprise at least one state variable and/or at least one process variable and/or at least one parameter suitable for determining at least one state variable and/or at least one process variable and/or a change in the state function and/or the process variables. Examples for human-adjustable parameters, may be a temperature, pressure, lighting, composition of the material or similar parameters set by technical means.

Human-non-adjustable parameters are parameters that cannot be controlled by humans. Human-non-adjustable parameters are parameters that may be adjusted due to natural conditions. Human-non-adjustable parameters may relate to the material and/or the surrounding of the material. Human-non-adjustable parameters may comprise state variables and/or process variables and/or at least one parameter suitable for determining at least one state variable and/or at least one process variable and/or a change in the state function and/or the process variable. Examples for human-non-adjustable parameters may be time, e.g. points in time, time intervals or the like, temperature, pressure, lighting, composition of the material or similar parameters set by natural conditions such as the weather.

Changing the human-adjustable and/or human-non-adjustable parameters may comprise changing the state function by changing at least one state variable and/or changing at least one process variable. State variable may be one of a set of variables used to describe the state of a system. The state of a system may be defined with a state function. The system may comprise the material and/or the at least a part of the surrounding of the material. State variables may be extensive and/or intensive state variables. Extensive variables may be for example volume, amount-of-substance, entropy, potentials such as thermodynamic potentials and number of particles. Intensive variables may be for example pressure and temperature. Process variables may be one of a set of process variables used to describe the course of a change in the state function. Examples for process variables may include work, heat and arc length. Metadata may be obtained by determining at least one state variable and/or at least one process variable and/or at least one parameter suitable for determining at least one state variable and/or at least one process variable and/or a change in the state function and/or of at least one process variable.

A model is suitable for determining an output based on an input. The model may comprise a reference model and/or a NIR model. A NIR model may be suitable for determining at least one target value based on NIR spectral data, preferably further based on metadata. A reference model may be suitable for determining at least one model-based reference value based on metadata. A model may be a mechanistic model, a data-driven model or a hybrid model. The mechanistic model, preferably, reflects physical phenomena in mathematical form, e.g., including first-principle models. A mechanistic model may comprise a set of equations that describe an interaction between the material and the NIR light thereby resulting in at least one target value and/or model-based reference value.

Preferably, the data-driven model is a classification model. The classification model may comprise at least one machine-learning architecture and model parameters. For example, the machine-learning architecture may be or may comprise one or more of: linear regression, logistic regression, random forest, piecewise linear, nonlinear classifiers, support vector machines, naive Bayes classifications, nearest neighbours, neural networks, convolutional neural networks, generative adversarial networks, support vector machines, or gradient boosting algorithms or the like. In the case of a neural network, the model can be a multi-scale neural network or a recurrent neural network (RNN) such as, but not limited to, a gated recurrent unit (GRU) recurrent neural network or a long short-term memory (LSTM) recurrent neural network.

The data-driven model may be trained based on training data. The term “training”, also denoted learning, as used herein, is a broad term and is to be given its ordinary and customary meaning to a person skilled in the art and is not to be limited to a special or customized meaning. Training may also include parametrizing. The term specifically may refer, without limitation, to a process of building the classification model, in particular determining and/or updating parameters of the classification model. Updating parameters of the classification model may also be referred to as retraining. Retraining may be included when referring to training herein.

The classification model may be at least partially data-driven. The classification model may be trained based on training data. NIR training data may comprise historical NIR spectral data and at least one reference value, preferably additionally metadata. NIR model may be trained with NIR training data. Reference training data may comprise at least one analytical reference value and historical metadata. Reference model may be trained with reference training data. Training the data-driven model may comprise providing training data to the model. The training data may comprise at least one training dataset. A training data set may comprise at least one input and at least one desired output. During the training the data-driven model may adjust to achieve best fit with the training data, e.g. relating the at least on input value with best fit to the at least one desired output value. For example, if the neural network is a feedforward neural network such as a CNN, a backpropagation-algorithm may be applied for training the neural network. In case of a RNN, a gradient descent algorithm or a backpropagation-through-time algorithm may be employed for training purposes.

Training a model may include or may refer without limitation to calibrating the model. The model may be suitable for measuring a desired value such as a target value and/or a reference value. The model may be referred to as a measuring system, e.g. for measuring a target value and/or a reference value. A NIR model may be trained, in particular retrained, with NIR training data which may not comprise analytical reference values, in particular only comprising model-based reference values. Training may comprise retraining.

“Computer-readable data medium” refers to any suitable data storage device or computer readable memory on which is stored one or more sets of instructions (for example software) embodying any one or more of the methodologies or functions described herein. The instructions may also reside, completely or at least partially, within the main memory and/or within the processor during execution thereof by the computer, main memory, and processing device, which may constitute computer-readable storage media. The instructions may further be transmitted or received over a network via a network interface device. Computer-readable data medium include hard drives, for example on a server, USB storage device, CD, DVD or Blue-ray discs. The computer program may contain all functionalities and data required for execution of the method according to the present invention or it may provide interfaces to have parts of the method processed on remote systems, for example on a cloud system. The term “non-transitory” has the meaning that the purpose of the data storage medium is to store the computer program permanently, in particular without requiring permanent power supply.

An input is configured to receive metadata related to at least one reference value and at least one analytical reference value. The input may comprise of one or more of serial or parallel interfaces or ports, USB, Centronics Port, FireWire, HDMI, Ethernet, Bluetooth, RFID, Wi-Fi, USART, or SPI, or analogue interfaces or ports such as one or more of ADCs or DACs, or standardized interfaces or ports to further devices.

A “processor” is a local processor comprising a central processing unit (CPU) and/or a graphics processing units (GPU) and/or an application specific integrated circuit (ASIC) and/or a tensor processing unit (TPU) and/or a field-programmable gate array (FPGA). The processor may also be an interface to a remote computer system such as a cloud service. The processor may include or may be a secure enclave processor (SEP). An SEP may be a secure circuit configured for processing the sensitive data. A “secure circuit” is a circuit that protects an isolated, internal resource from being directly accessed by an external circuit. The processor is suitable for determining the at least one model-based reference value based on the metadata with a reference model which has been trained by training data comprising at least one analytical reference value and metadata. To this end, the processor may have a model module comprising a model, preferably reference model and/or NIR model. Secure circuitry is especially advantageous in the case of confidential spectral data.

An output is configured to output the at least one model-based reference value. An output may comprise of one or more of serial or parallel interfaces or ports, USB, Centronics Port, FireWire, HDMI, Ethernet, Bluetooth, RFID, Wi-Fi, USART, or SPI, or analogue interfaces or ports such as one or more of ADCs or DACs, or standardized interfaces or ports to further devices.

In some embodiments, the at least one target value may be determined based on NIR spectral data and metadata. By doing so, the interpretation of NIR spectral data and the measurement of at least one target value is improved since the metadata is related to the NIR spectral data. Followingly, the representation of the conditions under which the data has been generated can be mapped more accurately and can be involved in the interpretation of the NIR spectral data. This provides the NIR model with information regarding the target value since metadata may also influence the target value. In this case, the NIR model may be trained with NIR training data comprising NIR spectral data, at least one reference value and metadata. Using at least one model-based reference value improves the measurement of target values. By doing so, less analytical reference values are required, thereby reducing the resources needed, reducing the amount of pollution and reducing the amount of time needed for determining analytical reference values.

In some embodiments, metadata may be generated with the same or similar human-adjustable and/or human-non-adjustable parameters as the NIR spectral data. Similar may refer to values of human-adjustable and/or human-non-adjustable parameters with a deviation up to 20%, preferably 10%. A deviation of 20% may be especially sufficient when determining qualitative information as an example for scenarios requiring less accuracy. In particular, quantitative information relies on more accurate results with highest deviation of 10%. Larger deviation may cause loss of significance of the material information. Metadata may be suitable for determining at least one model-based reference value. Using at least one model-based reference value improves the measurement of target values. By doing so, less analytical reference values are required, thereby reducing the resources needed, reducing the amount of pollution and reducing the amount of time needed for determining analytical reference values. Additionally, the interpretation of NIR spectral data is improved since the metadata is related closely to the NIR spectral data. Followingly, the representation of the conditions under which the data has been generated can be mapped more accurately.

In some embodiments, the metadata may be generated at the same or similar point in time and/or same or similar location as the NIR spectral data may be generated. In that sense, the same or similar point in time may refer to a deviation between the point in time of generating the metadata and the point in time of generating the corresponding NIR spectral data of one day, preferably 10 hours, most preferably 1 hour. In that sense, the same or similar location may refer to a deviation between the location where the metadata may be generated and the location where the corresponding NIR spectral data may be generated of 10 km, preferably 3 km, most preferably 500 m. Using at least one model-based reference value improves the measurement of target values. By doing so, less analytical reference values are required, thereby reducing the resources needed, reducing the amount of pollution and reducing the amount of time needed for determining analytical reference values. Additionally, the interpretation of NIR spectral data is improved since the metadata is related closely to the NIR spectral data. Followingly, the representation of the conditions under which the data has been generated can be mapped more accurately.

In some embodiments, model-based reference values may be used for retraining the NIR model. By adding more reference values, the accuracy and/or precision of the NIR model can be increased. Using at least one model-based reference value improves the measurement of target values. By doing so, less analytical reference values are required, thereby reducing the resources needed, reducing the amount of pollution and reducing the amount of time needed for determining analytical reference values.

In some embodiments, the at least one model-based reference value may be used for training including retraining at least one reference model other than the reference model that determined the at least one model-based reference value (“other reference model”). The other reference model may be a reference model with additional data input compared to the reference model. By doing so, the other reference model may be suitable for more use cases by providing more or more accurate or more precise model-based reference values. Using at least one model-based reference value improves the measurement of target values. By doing so, less analytical reference values are required, thereby reducing the resources needed, reducing the amount of pollution and reducing the amount of time needed for determining analytical reference values.

In some embodiments, the model may be a hybrid model. A hybrid model may be a classification model comprising at least one machine-learning architecture with mechanistic or statistical adaptations and model parameters. Statistical or mechanistic adaptations may be introduced to improve the quality of the model-based reference values since those provide a systematic relation between empiricism and theory. Statistical or mechanistic adaptations may comprise limitations of any intermediate or final results (model-based reference values) determined by the classification model and/or additional input for (re-)training the classification model. A hybrid model may be more accurate than a purely data-driven model since, especially with small data sets, purely data-driven models may tend to overfitting. This can be circumvented by introducing knowledge in the form of mechanistic adaptations.

In some embodiments, the NIR spectral data and/or the at least one model-based reference value and/or the at least one analytical reference value and/or the metadata and/or in particular the historical NIR spectral data and/or the historical metadata may be provided.

In some embodiments, metadata may be further inputted into the NIR model. Metadata provides additional information related to the system analysed by NIRS. More information allows for a more accurate relation of input and output. Thus, inputting more information improves the measurement of target values and in the interpretation of NIR spectral data.

In some embodiments, the at least one target value, the reference model and/or the NIR model may be received.

In some embodiments, the measure of the target value may be provided by a user. Providing may include selecting. The user may desire to determine at least one target value and/or measure of the target value. The user may select the at least one target value and/or measure of the target value from a predetermined list, in particular suggestions by an application. User selecting the target value and/or the measure of the target value provides user control and enables easy, fast and reliable NIR spectra interpretation for all users. In particular, users with less knowledge about NIRS benefit from the possibility of selecting the result to be determined without the need of in-deep knowledge about NIRS, thereby allowing the user concentrate on the result and/decisions referring to the result. Using at least one model-based reference value improves the measurement of target values. By doing so, less analytical reference values are required, thereby reducing the resources needed, reducing the amount of pollution and reducing the amount of time needed for determining analytical reference values.

In some embodiments, the target value and/or the reference value may comprise material information.

In some embodiments, the metadata may be generated with a device suitable for generating NIR spectral data and/or connected to a device suitable for generating NIR spectral data. A device suitable for generating NIR spectral data may comprise a NIR spectrometer. A device suitable for generating NIR spectral data and metadata may comprise a NIR spectrometer and part suitable for determining the metadata. The device may be connected via a wired and/or wireless connection such as one of ethernet, USB, LAN, WLAN, Bluetooth and the like. By doing so, the time and effort for the user is reduced.

In some embodiments, the NIR spectral data may be generated by a spectrometer. In particular, a handheld spectrometer.

In some embodiments, the at least one model-based reference value may be compared to an analytical reference value. Further, the at least one model-based reference value may be compared to a target value. Further, the at least one target value may be compared with the at least one analytical reference value. In particular, the at least one target value may be compared to the at least one reference value and a deviation may be determined based on the comparison between the at least one target value and at least one reference value. This analytical reference value may not have been provided to the reference model and/or the NIR model during the training. By comparing the values, accuracy and precision of the model can be investigated. Comparing the at least two values may be a validation step. Based on the comparison a deviation between the at least two values may be determined. The deviation may be an absolute deviation or a relative deviation. An absolute deviation may be an absolute value of the result of subtracting one of the at least two values from the other. The absolute deviation may be a numerical value. Absolute deviation may be a positive, zero and/or negative value. A relative deviation may be an absolute value of the result of subtracting one of the at least two values from the other value and dividing the result by the other value. The relative deviation may be a percentage or another numerical value. A threshold may correspond to a value of a deviation. The threshold may be related to a maximum fault tolerance. Comparing the deviation to the threshold may result in deviation lower than the threshold or deviation equal or larger than the threshold. A deviation equal or larger than the threshold may indicate that the model may be retrained. A deviation lower than the threshold may indicate that the model may not be retrained. The threshold may be selected based on the desired accuracy of the model. Reaching a low deviation may be advantageous for the accuracy of the model. Such model may be robust, accurate and widely applicable among many different use cases and/or in a divergent field. Models with higher deviation may be advantageous in only slightly heterogeneous and/or more homogenous fields since such models require less data input and provide a time-efficient training.

In particular, the NIR model and/or the target value may be provided and/or used when the deviation is lower compared to a threshold and wherein the NIR model is retrained according to the training method disclosed above when the deviation is equal or larger compared to the threshold.

Comparing the non-analytical reference and/or target values with the analytical or model-based reference value may provide a measure for the accuracy of the reference model or the NIR model. By testing the accuracy, accurate models may be obtained and can be applied without taking the time and energy to perform further training. Also, inaccurate models can be identified and retrained to increase the accuracy sufficient for the purpose of the model. This may prevent from inaccurate values. Validation of the reference model is of special importance since the output of reference model can be used as input for further training and the inaccuracy of the reference model may be reproduced or attenuated by the NIR model, known as fault propagation. Fault propagation may be prevented by validation tests of the reference model.

Further possible implementations or alternative solutions of the invention also encompass combinations—that are not explicitly mentioned herein-of features described above or below in regard to the embodiments. The person skilled in the art may also add individual or isolated aspects and features to the most basic form of the invention. It shall be understood that a preferred embodiment of the invention can also be any combination of the dependent claims or above embodiments with the respective independent claim.

Further embodiments, features and advantages of the present invention will become apparent from the subsequent description and dependent claims, taken in conjunction with the accompanying drawings.

### BRIEF DESCRIPTION OF THE FIGURES

FIG. 1 illustrates a flow diagram of an example embodiment of a method for measuring a target value (100).

FIG. 2 illustrates a flow diagram of an example embodiment of a method for training a reference model suitable for providing a model-based reference value (200).

FIG. 3 illustrates a block diagram of an example embodiment of a system for providing a model-based reference value (300).

FIG. 4 illustrates an exemplary use case of the invention in the field of watering an agricultural area with crops (400).

FIG. 5 illustrates a block diagram of an example embodiment of a system for training a reference model (500).

FIG. 6 illustrates a flow diagram of an example embodiment of a method for providing a model-based reference value (600).

FIG. 7 illustrates a flow diagram of an example embodiment of a method for training a NIR model suitable for providing a target value (700).

FIG. 8 illustrates a block diagram of an example embodiment of a system for measuring a target value (800).

FIG. 9 illustrates a block diagram of an example embodiment of a system for training a NIR model (900).

FIG. 10 illustrates an exemplary embodiment of the invention in the field of determining the water content an agricultural area with crops (1000).

FIG. 11 illustrates an exemplary embodiment involving retraining of the NIR model (1100).

### DETAILED DESCRIPTION OF EMBODIMENTS

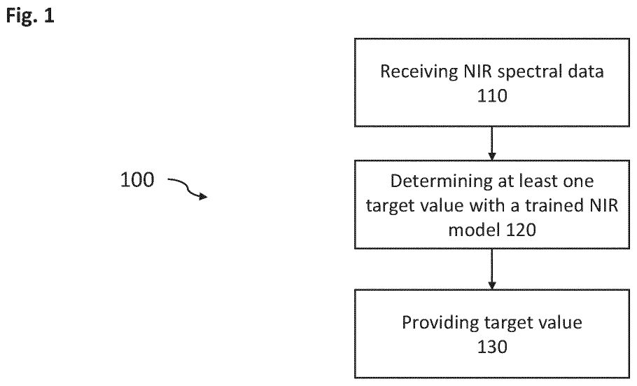

In FIG. 1 a flow diagram of an example embodiment of a method for providing a target value is pictured (100).

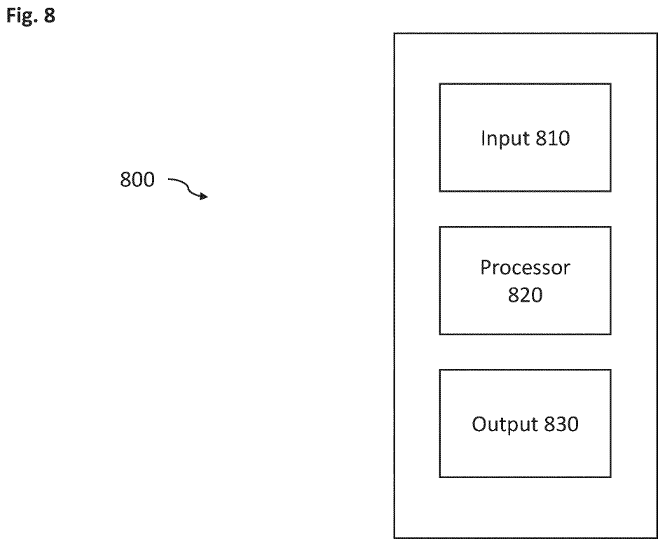

In a first step, NIR spectral data suitable for training a NIR model, at least one model-based reference value determined based on metadata provided to a reference model and NIR spectral data suitable for determining at least one target value with a NIR model is received (110). The data may be provided by a user. The user may desire to determine at least one target value. The user may further provide the desired measure of a target value. The data may have been generated the by the user using a NIR spectrometer. The user may be using an application on a smartphone to provide the data and/or select the desired measure of a target value. In other embodiments, the user may be uploading the data to a webpage and/or select the desired measure of a target value in a web interface. The data and/or the desired measure of a target value may be received via the web interface and/or the application. The data and/or the selection of the target value may be transmitted to a processor suitable for processing the data and the request for the target value. Such a processor may be comprised in a system as described in the context of FIG. 8. For example, the processor may be part of a decentralized computational network such as a cloud infrastructure or in a local computer. In some embodiments, metadata associated with the conditions of generating the NIR spectral data may be received. For determining the at least one model-based reference value, a reference model may be trained in order to match metadata associated with the generation of NIR spectral data with reference values. For this purpose, the reference model is trained with metadata and at least one analytical reference value. This trained reference model may then be used to determine a model-based reference value in response to receiving metadata associated with spectral data suitable for training a NIR model.

In a next step, the at least one target value is determined with the trained NIR model (120). For this purpose, the NIR model may be provided with NIR spectral data. The NIR model is trained based on the NIR training data comprising NIR spectral data and the at least one model-based reference value. The at least one model-based reference value may also be referred as to the target value corresponding to the received NIR spectral data. By providing data sets comprising target value corresponding to the received NIR spectral data and NIR spectral data suitable for training the NIR model, the model may be trained to match NIR spectral data with target values. In some embodiments, the NIR model may be further provided with metadata associated with the conditions of generating the NIR spectral data. An increased amount of data input may increase the accuracy and/or precision of the trained model. This NIR spectral data may be NIR spectral data not used for training the NIR model. The NIR spectral data may be associated with yet unknown target values. By providing the NIR spectral data to the NIR model, the NIR model may determine at least one corresponding target value based on the parameters determined during training. In some embodiments, metadata associated with the NIR spectral data may be fed into the NIR model for determining the target value more exactly. Examples for target value and/or reference value may be but are not limited to qualitative information such as presence of a functional group and/or structure element and/or quantitative information such as concentration and/or amount of a substance and/or material property such as color, e.g. due to presence of coloring substance.

In a last step, the at least one target value is provided (130). The at least one target value may be provided to a user that may have provided the NIR spectral data suitable for training a NIR model, the at least one model-based and the NIR spectral data suitable for determining at least one target value with a NIR model. The at least one target value may be a value that the user requested and/or selected. The at least one target value may be associated with the chemical identity of a material, such as characterizing the material as a liquid comprising water, sucrose, protein and salt. Furthermore, the molar/volume/mass content of the substances may be determined such as 75% water content, 10% sucrose content and 4% protein content and 1% salt content. With knowledge about the material being a liquid and the content of the several substances in the liquid, one may deduce corresponding properties such as viscosity. All of the herein given examples of information to be derived from NIR spectral data may correspond to qualitative information, quantitative information and/or material properties.

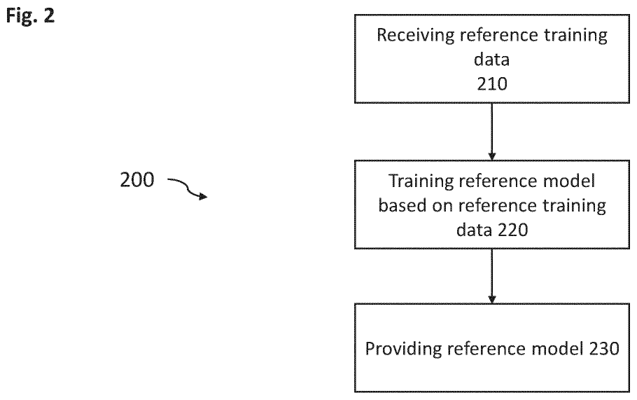

In FIG. 2 a flow diagram of an example embodiment of a method for training a reference model suitable for providing a model-based reference value (200) is pictured.

In a first step, reference training data comprising at least one analytical reference value and metadata related to at least one reference value is received (210). The reference training data may be received from the device generating the data and/or from a data storage. Such a data storage may be a cloud infrastructure for example.

In a next step, the reference model is trained based on the training data (220). During the training process, the data-driven model is adjusted to best fit the training data sets. Often, it is useful to use some of the data sets as validation data sets in order to verify if the data-driven model yields sufficiently reliable values for the determination of the model-based reference values and/or target values. If this is not the case, the user may be invited to add further training data sets by repeating steps 210 to 260. Once, the model is trained, it can be deployed.

By training a reference model more reference values may be fed into the NIR model for purposes of training since model-based reference value are readily on hand and can be determined whenever needed. More reference value involved in the training of the NIR model may improve the accuracy and/or may lower the time needed to train a NIR model with similar accuracy as a conventionally trained NIR model, thereby lowering the resources needed for training the NIR model. Resources needed for training includes electrical power. By lowering the amount of electrical power needed, the negative environmental impact caused by the production of electrical power produced is decreased.

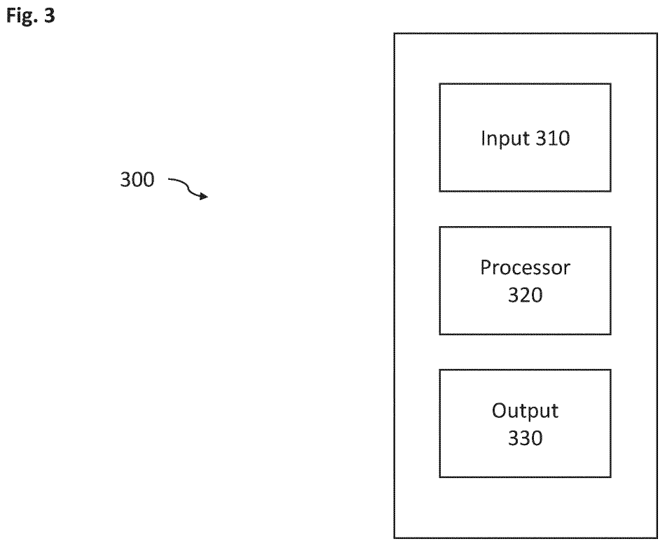

In FIG. 3 a block diagram of an example embodiment of a system for providing a model-based reference value (300) is pictured.

The system may comprise an input (310). The input (310) is suitable for receiving metadata. The input (310) may be connected to another device. Such a device may be suitable for generating NIR spectral data, metadata, and/or reference values. In some embodiments, the input (310) may be connected to a data storage, such as a cloud infrastructure. In such a data storage, NIR spectral data, metadata and/or reference values may be stored and may be suitable for being provided. The input (310) may be suitable for receiving a reference model. The reference model may be provided by the cloud infrastructure or any other processor connected to an output suitable for training a reference model.

Further, the system may comprise a processor (320). The processor is suitable for determining the at least one model-based reference value based on the metadata with a reference model which has been trained by training data comprising at least one analytical reference value and metadata.

Further, the system may comprise an output (330). The output is suitable for outputting the at least one model-based reference value. The output may be connected to a data storage. The model-based reference value may be assigned to the metadata.

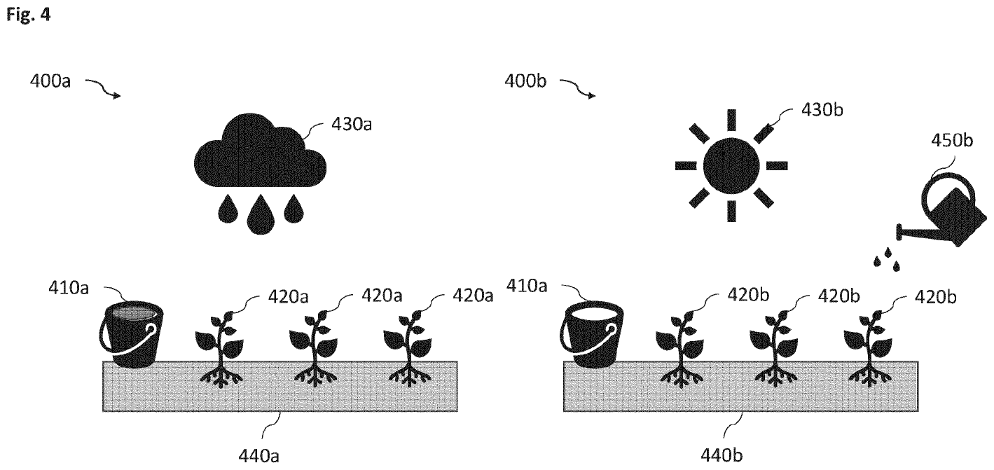

In FIG. 4 an exemplary use case of the invention in the field of watering an agricultural area with crops (400) is pictured.

NIR spectroscopy constitutes an easy and fast method for gaining information about chemical species (e.g. with handheld spectrometers for in-field spectral analysis), but its spectra are unfortunately difficult to interpret due to strongly overlapping bands compared to bands in the middle infrared spectra. Therefore, NIR models are used for the analysis. This is known as chemometrics in the state of the art. Such NIR models may be trained with NIR training data comprising among others of reference values. Normally, such reference values can be generated by taking samples.

In the exemplary use case, NIR spectroscopy is used to analyze the moisture content of an agricultural area (440a/b) with crops (420a/b) to ensure sufficient hydration of the crops. This is usually associated with time-consuming work to take the samples from the soil, transferring the samples to an analytical laboratory and performing accurate analytical analysis, not mentioning potential waiting time due to unavailable capacity. Since the analytical analysis is normally performed by experts, costs are another factor accompanying analytical analysis. Hence, it is advantageously to reduce or even avert the amount of necessary analytical analysis. To do so, model-based reference values are required. These may be generated by deploying a reference model. Trained reference model receive metadata and determine based on the metadata at least one model-based reference value which is then output as described in the context of FIG. 1. The metadata received may comprise parameters related to the reference values.

In this example, the reference value that may be obtained is the water content of the soil. A certain water content is aimed for the crops (420a/b). This measure may be determined by taking a sample of the soil and analyzing the soil with analytical methods being costly and time consuming as described above. The water content of the soil depends on the one hand of the water provided from outside due to the weather condition (430a/b) and supplementary watering (450b) normally performed by the human to take care of the crops (420a/b). On the other hand, only a degree of the water amount can actually enter the soil due to evaporation of the water. The amount of water evaporating depends strongly on the ability of the soil to soak the water. The two factors being the amount of water soaked by the soil and the amount of water evaporated refer to two properties determining the water content change. With knowledge about the water content at one point in time, the change in water content can be determined based on the two factors, the amount of watering and the point in time for which the water content is desired are known. By doing so, the temporal evolution can be determined to yield a specific water content at the selected point in time.

The water content at one point in time may be an analytical reference value. To increase the accuracy, water content at other points in time may be selected as additional reference values. The amount of provided water may be a part of metadata. The amount of provided water may be measured directly by determining the water amount at one part of the agricultural area (440a/b) collecting passively water, e.g. with a bucket (410a/b). The generation of metadata may be for example integrated into agricultural machines such as tractors or performed via sensors installed on the agricultural area. On sunny days (430b), the agricultural area (440b) may be watered by the human (450b) taking care of the crops (420a/b) with a known amount of water, whereas on rainy days, the rain (430a) may water the agricultural area (440a). Evaporation rate and soaking rate may be specific for the agricultural area (440a/b) and the crops (420a/b). The evaporation and soaking rate may depend on the weather conditions such as temperature, humidity, sun exposure or the like. Thus, weather conditions may be comprised in the metadata. Evaporation rate and soaking rate may be specific for the agricultural area (440a/b). Furthermore, the point in time at which the water content is to be determined may be comprised in the metadata. In a certain period of time, at least one analytical reference value and metadata as described above may be collected as reference training data and used for the training as described in the context of FIG. 2. For deploying the reference model, metadata may be used as input based on which the reference model outputs at least one model-based reference value. In an example, if the weather conditions, the agricultural area (440a/b) and/or the crops (420a/b) change, the reference model may be retrained with other metadata and/or at least another analytical reference value to adjust to the changes.

In the exemplary case, the evaporation and soaking rate may be parameters suitable for determining at least one state variable, namely determining the amount-of-substance fraction of water in the soil. Other state variables may be temperature or pressure. In the exemplary case of an agricultural area (440a/b) the at least one state variable and/or the at least one parameter suitable for determining the at least one state variable may usually be human-non-adjustable parameters since the natural conditions such as the weather may cause adjustments. In certain use cases, e.g. where the crops are especially valuable and/or sensitive and/or inside a greenhouse, the at least one state variable and/or the at least one parameter suitable for determining the at least one state variable may be human-adjustable. For this purpose, technical means may be applied. Considering the volume characterized by the base area being the agricultural area (440a/b) starting at the roots of the crops and reaching up to the end of the crops as the system.

When the model-based reference value is generated as described in the context of FIG. 2 a NIR model may be trained based on historical NIR spectral data and the at least one model-based reference value. The NIR model may be suitable for determining future water content of soil. For this purpose, NIR spectral data may be generated of the soil on the agricultural area, e.g. with a handheld spectrometer or with another portable device such as a smartphone.

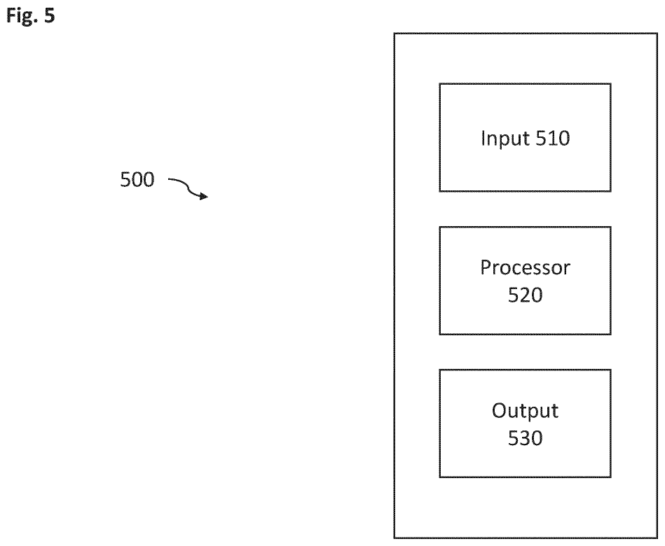

In FIG. 5 a block diagram of an example embodiment of a system for training a reference model (500) is illustrated.

The system may comprise an input (510). The input (510) is suitable for receiving metadata and at least one analytical reference value. The input (510) may be connected to another device. Such a device may be suitable for generating metadata, and/or reference values. In some embodiments, the input (510) may be connected to a data storage, such as a cloud infrastructure. In such a data storage, metadata and/or reference values may be stored and may be suitable for being provided.

Further, the system may comprise a processor (520). The processor is suitable for training a reference model with training data comprising at least one analytical reference value and metadata. The processor (520) may further be suitable for implementing the reference model.

Further, the system may comprise an output (530). The output is suitable for outputting the reference model. The output (530) may be connected to a processor that is suitable for providing input to the reference model and implementing the reference model. For this purpose, the processor may be connected to the output (530) and/or may comprise a model module.

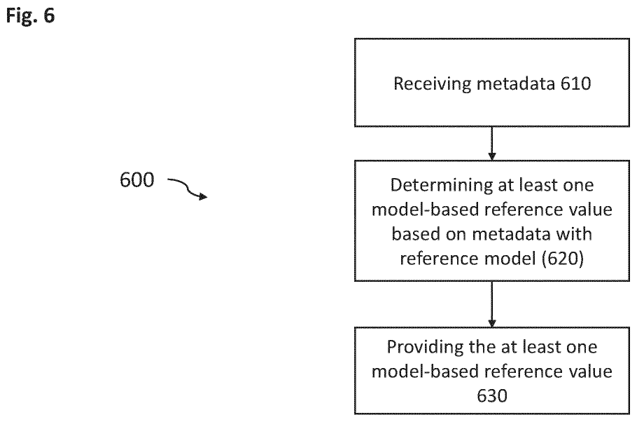

In FIG. 6 a flow diagram of an example embodiment of a method for providing a model-based reference value (600) is pictured.

In a first step, metadata related to at least one reference value is received (610). The metadata may be received from a device suitable for generating metadata, e.g. a thermometer for measuring a temperature or a watch for determining a point in time or an time interval. For the determination of the human-adjustable and human-non-adjustable usually suitable devices are usually easily accessible. In some embodiments, the device may further be suitable for determining NIR spectral data. Metadata may be received from a data storage. Metadata may be generated non-invasively. In a scenario where a composition of a material may be determined with NIRS, the temperature may influence the content of specific components such as water content. Water content may be lower at higher temperatures and low humidity and higher at lower temperatures and high humidity.

In a next step, the at least one model-based reference value is determined based on the metadata by using a reference model which has been trained by reference training data comprising at least one analytical reference value and metadata (620). The metadata may be inputted into the reference model. During the training the reference model may be trained such as to determine the at least one model-based reference value with best fit.

In a last step, the at least one model-based reference value is output (630). The at least one non-analytical value may be provided to a NIR model and/or a reference model. The at least one non-analytical value may be used for further determination of reference values and/or target values.

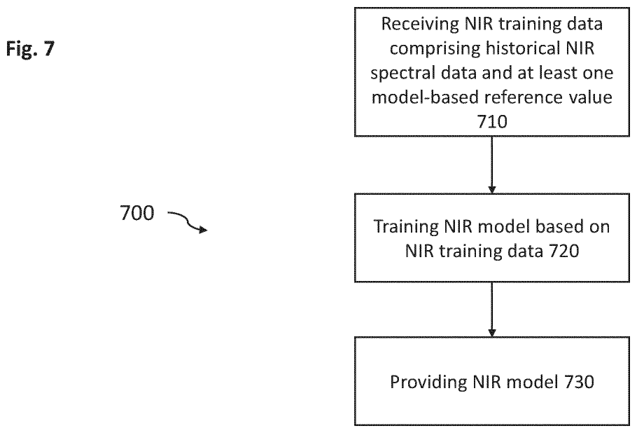

FIG. 7 illustrates a flow diagram of an example embodiment of a method for training a NIR model suitable for providing a target value (700).

In a first step, NIR spectral data and at least one model-based reference value determined based on metadata is received and provided to a reference model (710). The NIR spectral data and the at least one model-based reference value may be provided by a user. The user may desire to determine at least one target value and thus, a NIR for determining the target value may be trained. This may be necessary since NIR models may differ significantly between different use cases. For example, a NIR model suitable for determining nutrient content in food may not be comparable with a NIR model suitable for determining contents in plastic materials as known in the state of the art. The user may have been generated the data by using a NIR spectrometer. The user may be using an application on a smartphone to provide the data and the at least one model-based reference value. In other embodiments, the user may be uploading the data to a webpage and/or select the desired target value in a web interface. The data and/or the desired target value may be received via the web interface and/or the application. The data and/or the selection of the target value may be transmitted to a processor suitable for processing the data and the request for the target value. Such a processor may be comprised in a decentralized computational network such as a cloud infrastructure or in a local computer. In some embodiments, metadata associated with the conditions of generating the NIR spectral data may be received. For determining the at least one model-based reference value, a reference model may be trained in order to match metadata associated with the generation of NIR spectral data with reference values. For this purpose, the reference model is trained with metadata and at least one analytical reference value. This trained reference model may then be used to determine a model-based reference value in response to receiving metadata associated with spectral data suitable for training a NIR model.

In a next step, the NIR model is trained based on the NIR spectral data and the at least one model-based reference value (720). The training may comprise a first parametrization of the NIR model with training data comprising NIR spectral data and at least one model-based reference value and a first validation of the NIR model with validation data comprising NIR spectral data. The NIR model may be provided with the validation data with known target values which may not be provided to the NIR model. The NIR model may be tested with the validation data by determining target values for the provided spectral data which may be compared to the known target values. Depending on the difference between the determine target value and the known target value may be determined. A large error may be in indication for repeating the training procedure by using training data for a second training. Such training data may be different than the training data of the first training. The procedure may be repeated until the error fulfills the criteria e.g. selected by the user. This may be determined by comparing the error to a predetermined threshold for the error. Depending on the required certainty and the use case for which the NIR model is trained, the threshold may be determined accordingly. A NIR model only used for determining qualitative information of a material without regarding the amount of at least one chemical substance in the material may be sufficient with a larger error margin than a NIR model used to determine mass content in a sub one percent range. An error equal or larger/smaller than the threshold may trigger retraining with another training data. After reaching an error lower/higher that the threshold, the NIR model may be ready for being deployed in order to determine target values based on NIR spectral data.

In a last step, the NIR model is provided (730). The NIR model may be provided to a user which may use the NIR model for determining a target value. The NIR model may be provided via an application and/or a web interface. In the application and/or the webpage, a user may be enabled to upload and/or provide spectral data and at least one model-based reference value. In some embodiments, the user may select at least a part of the spectral data and the at least model-based reference value. Depending on the selection of the user, NIR models may be trained differently since the training data selected by the user may be different. In some embodiments, the user may be provided with the at least one model-based reference value in response to providing metadata and at least one analytical reference value. The user may be provided with the at least one model-based reference value as described in the context of FIG. 6.

FIG. 8 illustrates a block diagram of an example embodiment of a system for measuring a target value (800).

A system for training a reference model suitable for providing a target value (800) comprises an input for receiving NIR spectral data suitable for training a NIR model, at least one model-based reference value determined based on metadata provided to a reference model and NIR spectral data suitable for determining at least one target value with a NIR model (810), a processor for training the NIR model based on the NIR spectral data suitable for training a NIR model and the at least one model-based reference value and determining the at least one target value with the trained NIR model (820), an output for providing the at least one target value (830).

The input (810) may be connected to another device. Such a device may be suitable for generating NIR spectral data, and/or at least one model-based target value. In some embodiments, the input (810) may be connected to a data storage, such as a cloud infrastructure. In such a data storage, NIR spectral data and/or at least one model-based reference value may be stored and may be suitable for being provided. The input may comprise a web interface and/or may be comprised in an application. Such an application may comprise a web application, smartphone and/or smartwatch application.

The processor (820) may be further suitable for training and/or implementing a reference model. Such a reference model may be suitable for trained in order to determine model-based reference values. In some embodiments, the NIR model may be trained and deployed in a decentralized computational network such as a cloud infrastructure. The computational network may balance the computational effort according to its dimensions and the workload on the network. In some embodiments, the workload of training the NIR model may be accomplished by a part different than the part responsible for stemming the workload of implementing the NIR model and determining the at least one target value.

The output (830) may be connected to a processor that may be suitable for training and implementing the NIR model. For this purpose, the processor may be connected to the output (830) and may comprise a model module. The output may comprise a web interface and/or may be comprised in an application.

Such a system may be applied in the exemplary case as described in the context of FIG. 4.

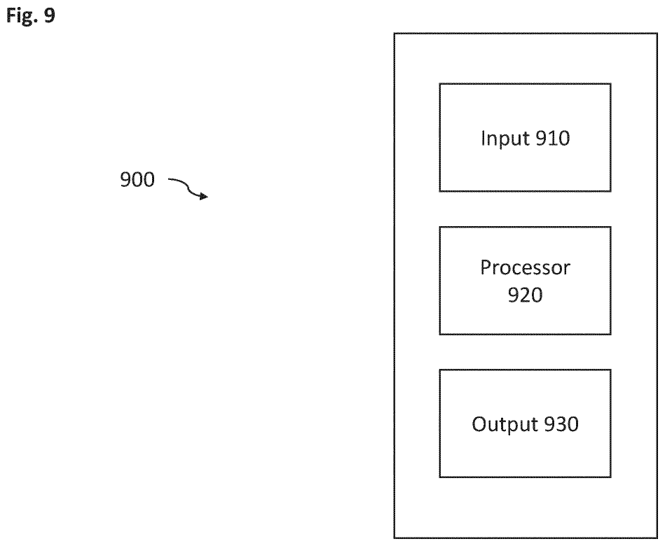

FIG. 9 illustrates a block diagram of an example embodiment of a system for training a NIR model (900).

A system for training a NIR model suitable for providing a target value comprises an input for receiving NIR training data comprising at least one model-based reference value and NIR spectral data (910), a processor for training the NIR model based on the NIR training data (920), an output for providing the NIR model (930).

The input (910) may be connected to another device. Such a device may be suitable for generating NIR spectral data, and/or at least one model-based target value. In some embodiments, the input (910) may be connected to a data storage, such as a cloud infrastructure. In such a data storage, NIR spectral data and/or at least one model-based reference value may be stored and may be suitable for being provided. The input may comprise a web interface and/or may be comprised in an application. Such an application may comprise a web application, smartphone and/or smartwatch application.

The processor (920) may be further suitable for training and/or implementing a reference model. Such a reference model may be suitable for trained in order to determine model-based reference values. In some embodiments, the NIR model may be trained in a decentralized computational network such as a cloud infrastructure. The computational network may balance the computational effort according to its dimensions and the workload on the network. In some embodiments, the workload of training the NIR model may be accomplished by different parts of the computational network.

The output (930) may be connected to a processor that may be suitable for training and implementing the NIR model. For this purpose, the processor may be connected to the output (930) and may comprise a model module. The output may comprise a web interface and/or may be comprised in an application. The NIR model may be provided to a user. The user may deploy the NIR model for determining at least one target value.

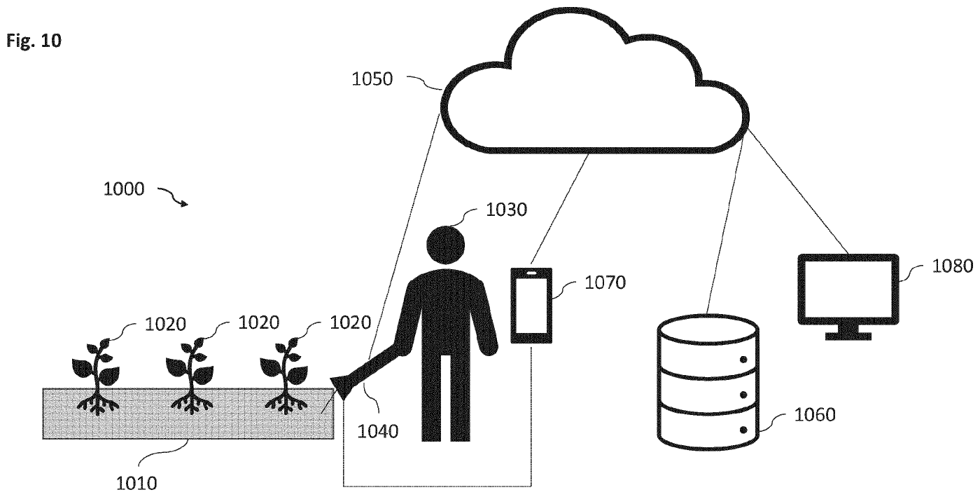

In FIG. 10 an exemplary embodiment of the invention in the field of determining the water content of an agricultural area with crops (1000) is illustrated.

The agricultural field may consist of soil (1010) and crops (1020) planted in the soil (1010). A user (1030) may desire to determine the water content of the soil (1020) in order to ensure optimal growing conditions. The user may be a farmer and may have planted the crops (1020). For determining the water content, the user may use a spectrometer (1040). In this exemplary case, the user may use a mobile device suitable for generating NIR spectral data, in particular a handheld spectrometer. With the spectrometer (1040), the user (1030) may generate NIR spectral data of the soil (1010). To do so, the spectrometer may comprise an illumination source for illuminating light, an optical element configured for separating incident light into a spectrum of constituent wavelength/wavenumber components and/or a photosensor arranged to receive light from the optical element. The light received by the photosensor may have interacted with the sample, in the example soil (1010). Chemical substances posses a unique absorption behavior in the NIR regime, thereby enabling the determination of material information with NIRS. The generated NIR spectral data may then be processed and/or stored. Storing and processing may be facilitated via a cloud computing infrastructure (1050). This infrastructure provides a fast and easy access to computer resources. NIR spectral data may be uploaded to at least a part of a server belonging to a cloud system (1050). This system may be in communication with the spectrometer (1040), external servers (1060) e.g. servers of the user, local computers (1080), or a mobile device of the user (1070). In general, all devices may be communicatively coupled. In FIG. 10, a connection for communication between devices is illustrated by a dotted line. As it can be seen, in the example the devices may be connected through the cloud system (1050) and the spectrometer (1040) and the personal mobile device (1070) may be connected to each other, e.g. wirelessly. By doing so, the user may access the NIR spectral data at any time and wherever wanted in a convenient way. The NIR spectral data may be processed by the cloud comping infrastructure in order to provide the user with results corresponding to the data generated by the user. Such a result may be a target value. The user may have selected a measure of the target value to be determined with the measurement. In the cloud computing infrastructure, the target value may be measured as described in the context of FIG. 1 with a NIR model that was trained as described in the context of FIG. 7. The NIR model was trained based on NIR training data comprising among other at least one model-based reference value. The model-based reference value may be determined as described in the context of FIG. 6 by using a reference model trained as described in the context of FIG. 2. The user may access the at least one target value by the mobile device (1070), e.g. a smartphone, by accessing a server (1060) owned by the client, by a local computer (1080) or by any other device with access to the cloud system (1050).

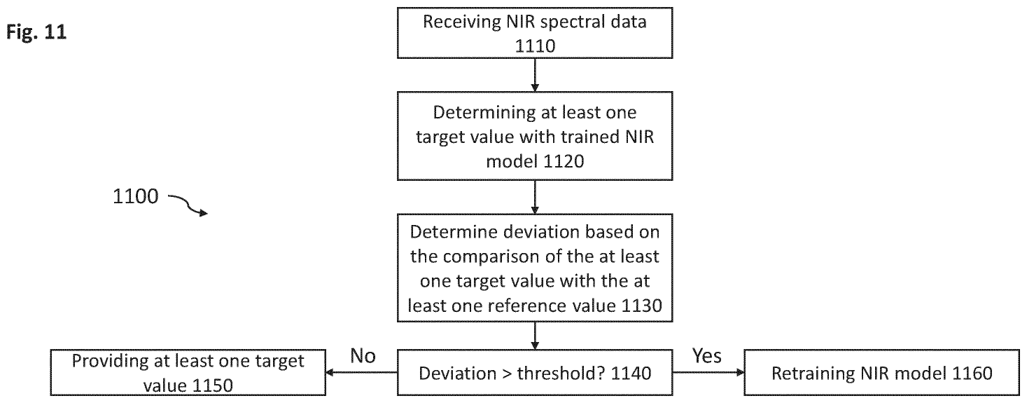

In FIG. 11 an exemplary embodiment involving retraining of the NIR model (1100) is illustrated.

In a first step, NIR spectral data are received (1110) as described in the context of FIG. 1.

In a next step, at least one target value is determined with a trained NIR model (1120) as described in the context of FIG. 1.

In a next step, the at least one target value may be compared to at least one reference value (1130). On the basis of the comparison, a deviation may be determined. The reference value may be a model-based and/or an analytical reference value. The reference value may have been generated with a reference model based on metadata corresponding to the NIR spectral data used for determining the target value. Comparing the at least one target value with the at least one reference value may include subtracting the at least one target value from the at least one reference value and/or vice versa, thereby resulting in a non-relative deviation. In some embodiments, the result of the subtraction may be divided by the at least one target value and/or by the at least one reference value, thereby resulting in a relative deviation. The deviation may comprise a numerical value, in particular an absolute value. Since the reference value may be considered to be the more accurate value, the deviation may account for determining an error of the at least one target value, ultimately an error of the NIR model when determining the at least one target value. High deviation may be a sign for bad accuracy of the NIR model. Thus, improving the accuracy of the NIR model may be desired. For this purpose, the NIR model may be retrained, when the deviation is considered to be too high.

Hence, in a next step, the deviation is compared to a threshold (1140). The deviation may be lower and/or equal to the threshold. In this case, the deviation may be considered appropriate and/or the NIR model may be considered accurate. The decision may be taken by the user or the user may have selected a threshold. In other scenarios, the threshold may refer to a predetermined value. In response to a deviation being lower and/or equal to the threshold, the target value may be provided (1150). The deviation may be higher and/or equal to the threshold. In this case, the deviation may be considered inappropriate and/or the NIR model may be considered inaccurate. In response to the deviation being higher and/or equal to the threshold, the NIR model may be retrained (1160). Retraining may include training a pretrained model with training data, in particular training data other than the training data used for the pretraining. Retraining may occur similar as described in the context of FIG. 7.

As used herein “determining” also includes “initiating or causing to determine”, “generating” also includes “initiating or causing to generate” and “providing” also includes “initiating or causing to determine, generate, select, send or receive”. “Initiating or causing to perform an action” includes any processing signal that triggers a computing device to perform the respective action.

1. A computer-implemented method for measuring a target value with a NIR model comprising:
(a) receiving NIR spectral data,
(b) determining at least one target value with the trained NIR model based on the spectral data, wherein the NIR model was trained based on NIR training data comprising at least one model-based reference value determined with a reference model and historical NIR spectral data, and
(c) providing the at least one target value.

2. A computer-implemented method for training a reference model suitable for providing a model-based reference value comprising:
(a) receiving reference training data comprising at least one analytical reference value and historical metadata related to at least one reference value,
(b) training the reference model based on the reference training data, and
(c) providing the reference model.

3. A computer-implemented method for training a NIR model comprising:
(a) receiving NIR training data comprising historical NIR spectral data and at least one model-based reference value determined with a reference model-based on metadata corresponding to the historical spectral data,
(b) training the NIR model based on the historical NIR spectral data and the at least one model-based reference value, and
(c) providing the NIR model.

4. The method according to claim 1, wherein the at least one target value as provided by the NIR model, is compared to the at least one reference value and a deviation is determined based on the comparison between the at least one target value and at least one reference value.

5. The method according to claim 4, further comprising the step of
(a) providing and/or using the NIR model when the deviation is lower compared to a threshold, or
(b) retraining the NIR model when the deviation is equal or larger compared to the threshold, according to a computer-implemented method for training a NIR model comprising:
receiving NIR training data comprising historical NIR spectral data and at least one model-based reference value determined with a reference model-based on metadata corresponding to the historical spectral data,
training the NIR model based on the historical NIR spectral data and the at least one model-based reference value, and
providing the NIR model.

6. The method according to claim 1, wherein metadata is further comprised in the training data and/or the NIR training data.

7. The method according to claim 1, wherein the NIR spectral data and/or the at least one model-based reference value and/or the at least one analytical reference value and/or the metadata and/or the historical NIR spectral data and/or the historical metadata are provided.

8. The method according to claim 1, wherein the at least one target value, the reference model and/or the NIR model are received.

9. The method according to claim 1 wherein the NIR model and/or the reference model are data-driven.

10. The method according to claim 1, wherein the target value and/or the reference value comprises material information.

11. The method according to claim 1, wherein the measure of the target value is provided by a user.

12. A method of using a model-based reference value as provided by a reference model according to claim 2, the method comprising using the model-based reference value for training a NIR model.

13. A system for measuring a target value comprising:
(a) an input for receiving NIR spectral data suitable for training a NIR model, at least one model-based target value determined based on metadata provided to a reference model and NIR spectral data suitable for determining at least one target value with a NIR model,
(b) a processor for training the NIR model based on the NIR spectral data suitable for training a NIR model and the at least one model-based reference value and determining the at least one target value with the trained NIR model, and
(c) an output for providing the at least one target value.

14. A computer program comprising instructions which, when the program is executed, carry out the steps of the methods according to claim 1.

15. A non-transitory computer-readable data medium storing the computer program according to claim 14.

16. The method according to claim 1, wherein historical metadata, is further comprised in the reference training data and/or the NIR training data.

17. The method according to claim 3, wherein historical metadata, is further comprised in the reference training data and/or the NIR training data.

18. A computer program comprising instructions which, when the program is executed, carry out the steps of the methods according to claim 2.

19. A computer program comprising instructions which, when the program is executed, carry out the steps of the methods according to claim 3.

20. A method of using a model-based reference value as provided by a reference model according to claim 7, the method comprising using the model-based reference value for training a NIR model.
